(19) United States
(12) Patent Application Publication
(10) Pub. No.: US 2024/0068171 A1
(43) Pub. Date: Feb. 29, 2024

(54) METHOD FOR PRODUCING A CONTAINER COMPRISING FIBERS AND DEVICE

(71) Applicant: Krones AG, Neutraubling (DE)

(72) Inventors: Frank WINZINGER, Regensburg (DE); Angelika GROSSER, Emmerting (DE); Barbara WEIN, Gonnersdorf (DE)

(21) Appl. No.: 18/365,727

(22) Filed: Aug. 4, 2023

(30) Foreign Application Priority Data
Aug. 25, 2022 (DE) 102022121459.1

(51) Int. Cl. D21J 7/00; D21J 3/10

(52) U.S. Cl. CPC D21J 7/00; D21J 3/10; B33Y 10/00

(57) ABSTRACT

The disclosure relates to a method for producing a container comprising fibers by means of a controlled application head that applies material comprising the fibers to container positions. The disclosure further relates to a device, for example for carrying out the method, wherein the device comprises at least one controlled application head for applying material comprising the fibers to container positions.

### CROSS REFERENCE TO RELATED APPLICATION

The present application claims priority to German Patent Application No. 102022121459.1 filed on Aug. 25, 2022. The entire contents of the above-listed application are hereby incorporated by reference for all purposes.

### TECHNICAL FIELD

The disclosure relates to a method for producing a container and a device, for example, for carrying out the method.

### BACKGROUND

In the case of container bodies produced from pulp by means of casting methods, it has been known to date to use a threaded region formed from plastic and attach it to the cast container body. Bonding the threaded region to the cast container body can be problematic in terms of tightness, barrier effect and strength.

### SUMMARY

### Object

The object of the disclosure is to provide a method for producing a container comprising fibers and a device, for example, for carrying out the method, which makes it possible to produce a container having sufficient tightness, barrier effect and strength.

### Achievement

The object is achieved by a method for producing a container and a device, for example, for carrying out the method as described herein.

The method according to the disclosure is for producing a container comprising fibers by means of a controlled application head that applies material comprising the fibers to container positions.

By producing a container comprising a material with fibers by means of a controlled application head, the fibers, for example paper fibers, can be applied dry or wet or as pulp to the container positions where the material is to be located in the produced container.

For example, bonding and/or joining points between container parts that have been produced, for example, using different production methods, wherein “different” can comprise different times and/or with different types of methods, can thus be avoided. By avoiding bonding and/or joining points between container parts, problems that can relate to tightness, barrier effect and/or moisture can be avoided.

It is possible to avoid bonding and/or joining points altogether. Thus, the container can be largely finished by means of the application head, filled with a product, and then closed by the same or another application head.

Alternatively, after producing a container open at the top by the application head and a filling of the container with product, a previously produced closure can be applied to the container, for example by screwing it on.

The production of a container open at the top by means of a mold and the closing of the container by means of the application head may also be comprised.

The material can be applied to an inner wall of a mold by means of the controlled application head and the container can be produced by pressing or molding by means of a balloon in the mold.

The material can be applied by means of a 3D printer, wherein a layered construction can be provided for the application, for example. For example, by using the 3D printer, the water content of the material comprising the fibers can be selected to be lower than when the material is applied to an inner wall of a mold using the controlled application head. Thus, in methods with a 3D printer, the drying phase of the produced container can be shorter.

A plurality of containers can be produced simultaneously by synchronizing a plurality of nozzles of the 3D printer. For example, all of the plurality of nozzles can be moved by a common drive.

The controlled application head can be moved by means of a multi-axis robot. The multi-axis robot can comprise a 3, 4, 5, 6 or 7-axis robot, for example a 3, 4, 5, 6 or 7-axis buckling arm robot.

By means of the controlled application head, the material can be applied to an already at least partially produced container for further producing a sub-element of the container and simultaneously connecting the sub-element to the already at least partially produced container. For example, the sub-element can comprise a mouthpiece and/or a handle and/or a thread. For example, the thread can then be pressed after the production of the thread.

By means of the controlled application head, at least one further fiber-containing material can be applied to container positions, wherein the at least one further fiber-containing material can be different from the material comprising the fibers.

For example, a further fiber-containing material can be used for a thread or a threaded region that requires a thread or a threaded region of higher stability than the rest of the container after the container is produced.

Identification and/or durability information can be embossed on the container using the controlled application head.

A press tool can be arranged on the application head or separately, by means of which the freshly applied mass can be pressed or compressed incrementally after application. For example, the press tool can comprise two opposing plates, each of which can be smaller than 5 cm², for example less than 1 cm², and can compress the applied material.

For example, the press tool can be arranged at least in regions around the application head.

Furthermore, a drying device for drying the material can be arranged on the device.

The drying device can comprise a blower.

The drying device and/or the press tool can be arranged on the application head or can be moved along the contour of the container by means of its own drives.

Inside the container, at least one support can be provided that can, for example, connect two or more inner regions of the container. Such a container can be an independent disclosure.

For example, by providing the at least one support, the container can have thinner wall thicknesses than a corresponding container without the at least one support.

“Inside the container” can mean that the at least one support is surrounded by the material during the material comprising the fibers production of the container by means of the controlled application head that applies material comprising the fibers to container positions. The at least one support can be embedded in the material comprising the fibers.

For example, a bottom region and a shoulder region or a bottom region and a side part region can be connected by means of the at least one support. For example, by providing the at least one support, the container can have a thinner bottom thickness than a corresponding container without the at least one support. The at least one support can be arranged to run obliquely.

For example, the at least one support can circumferentially connect a side part region and a shoulder region. The at least one support can be designed to extend horizontally. It can be used for pressure resistance of the container when filled with a product containing carbon dioxide. It can also, or alternatively, be used to provide additional stability during the action of a dynamic pressure on the container during transport on a transporter.

For example, the at least one support can circumferentially connect a side part region and a bottom region. The at least one support can be designed to extend horizontally. It can be used for pressure resistance of the container when filled with a product containing carbon dioxide.

The supports can comprise a tension band for a bottom of the container and/or at least one horizontally circulating tension band and/or at least one obliquely extending tension band. For example, these tension bands can comprise long-fiber material.

An obliquely extending tension band connecting the bottom and a side part region prevents an outer curvature of the bottom when, for example, a product containing carbon dioxide is filled into the produced container.

For example, a center of the bottom region and a shoulder region or a center of the bottom region and a side part region can be connected by means of the at least one support.

The support can act as a tension band that counteracts an extension of the bottom region or the center of the bottom region away from the center (usually when the container is standing on the ground in the direction of the center of the earth) of the container.

A bottom of the container can comprise multiple segments, for example circular segments. A bottom thickness of the segment can be smaller than a bottom thickness of a partition wall of the segments. For example, the stability of a produced container can thereby be increased.

A partition wall of the segments can comprise properties similar to a tension band.

An inner region of the container can be formed in a flow-optimized manner by means of the controlled application head. For example, the process of filling the container with product can be facilitated with regard to product inflow. The inner region can comprise an inner surface of the container.

A coating can be applied to an inner surface, also referred to as an inner layer, and/or an outer surface of the produced container by means of a 3D printer. For example, the coating can comprise a nanolayer. Two inner layers can be provided, wherein the nanolayer can represent the inner layer of the inner layers. The nanolayer can comprise silicon atoms.

A coating on the inner surface can prevent passage of a product filled into the container through the material comprising the fibers.

A coating can be applied to an outer surface of the produced container by immersion in a coating bath. For example, the coating can comprise a resin. By coating the outer surface, the container can additionally be protected against external influences.

The device can comprise at least one controlled application head for applying material comprising the fibers to container positions.

The device can further comprise a 3D printer. The 3D printer can comprise a plurality of nozzles with which, for example, a plurality of containers can be produced simultaneously. For example, all of the plurality of nozzles can be moved by a common drive.

The device can further comprise a multi-axis robot for moving the at least one controlled application head. For example, the multi-axis robot can comprise a hydraulic, pneumatic, electromechanical or hydropneumatic actuator.

The device can comprise a mixing vessel for mixing fibers with other components, for example a liquid, for example water, and for example a feed line from the mixing vessel to the application head. A pump can be arranged along the feed line.

The device can further comprise a filler for filling a beverage into the container.

The device can comprise a labeling machine for labeling the container with a label and/or a printer for printing the container with ink or paint or the like.

The device can further comprise a packer for packaging the container with further containers, for example to form packs.

The device can further comprise a palletizer for palletizing containers or the packs.

The device can comprise a transport system that can transport the containers from the application head to one or more of the aforementioned fillers, labeling machines, packers and/or palletizers. The transport system can comprise conveyor belts and/or grippers.

### BRIEF DESCRIPTION OF THE FIGURES

The accompanying Figures show, by way of example, aspects and/or exemplary embodiments of the disclosure for better understanding and illustration. In the figures:

FIG. 1 shows a container with two horizontally circulating tension bands,

FIG. 2 shows a container with two obliquely extending tension bands,

FIG. 3 shows a container with two obliquely extending supports, a horizontally circulating tension band and a horizontally circulating support, and

FIG. 4 shows a container, wherein the bottom comprises multiple segments.

### DETAILED DESCRIPTION

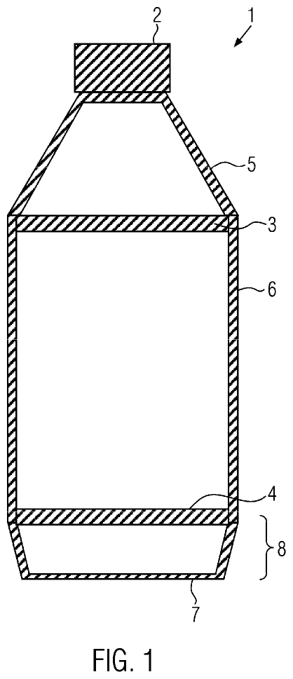

FIG. 1 shows a container 1 with two horizontally circulating tension belts 3, 4. The container 1 comprises a shoulder region 5, a side part 6, a bottom region 8 having a bottom 7 and a non-visible thread that is covered by a cover 2. The horizontally circulating tension band 3 connects the shoulder region 5 and the side part 6 and the other horizontally circulating tension band 4 connects the side part 6 and the bottom region 8. As a result, they can be used for pressure resistance of the container 1, for example when filled with a product containing carbon dioxide.

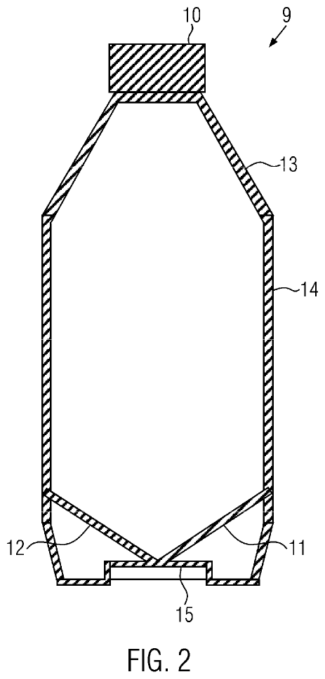

FIG. 2 shows a container 9 with two obliquely extending tension bands 11, 12. The container 9 comprises a shoulder region 13, a side part 14, a bottom 15 and a non-visible thread that is covered by a cover 10. The two obliquely extending tension bands 11, 12 connect the bottom 15 and the side part 14. By means of the obliquely extending tension bands 11, 12, an outer curvature of the bottom 15 can be prevented if, for example, the container 9 is filled with a product containing carbon dioxide.

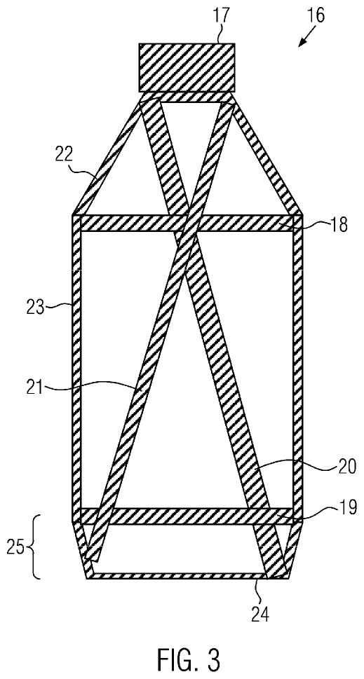

FIG. 3 shows a container 16 with two obliquely extending supports 20, 21, a horizontally circulating tension band 19 and a horizontally circulating support 18. The container 16 comprises a shoulder region 22, a side part 23, a bottom region 25 having a bottom 24 and a non-visible thread that is covered by a cover 17.

The two obliquely extending supports 20, 21 connect the bottom region 25 and the shoulder region 22. As a result, the stability of the bottom 24 can be increased.

The horizontally circulating tension band 19 connects the side part 23 and the bottom region 25. As a result, a pressure resistance of the container 16 can be increased, for example when filled with a product containing carbon dioxide.

The horizontally circulating support 18 connects the shoulder region 22 and the side part 23. The support 18 can be used for additional stability during the action of a dynamic pressure on the container 16 during transport on a transporter.

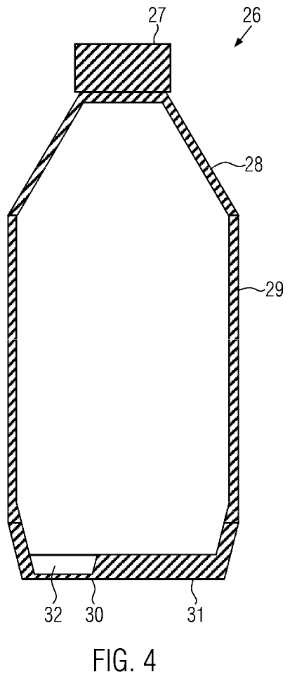

FIG. 4 shows a container 26, wherein the bottom 30 comprises multiple segments 32 that are divided by partition walls 31. A bottom thickness of the segment 32 is smaller than a bottom thickness of a partition wall 31 of the segments 32.

The container 26 comprises a shoulder region 28, a side part 29, the bottom 30 and a non-visible thread that is covered by a cover 27. In the case of increased pressure in the container 26, for example when filled with a product containing carbon dioxide, the segment 32 can yield more and form a base, several of which, for example five, can be provided along the circumference. The stability can be increased.

In all embodiments shown, it is possible for a different closure to be provided. In addition, the number of supports and tension bands shown can be varied—for example one, two, three or more further horizontal tension bands could be provided between the two tension bands shown.

Furthermore, the containers can alternatively or additionally comprise vertically extending tension bands that extend at least in regions along the outer contour of the containers. Two, three, four, five or more belts can be provided along the circumference of these tension bands.

Other types of containers would also be possible, for example can-shaped containers.

1. A method for producing a container comprising fibers by means of a controlled application head that applies material comprising the fibers to container positions.

2. The method according to claim 1, wherein the material is applied to an inner wall of a mold by means of the controlled application head and the container is produced by pressing or molding by means of a balloon in the mold.

3. The method according to claim 1, wherein the material is applied by means of a 3D printer, wherein a layered construction is provided for the application.

4. The method according to claim 1, wherein the controlled application head is moved by means of a multi-axis robot.

5. The method according to claim 1, wherein the material is applied to an already at least partially produced container by means of the controlled application head for further producing a sub-element of the container and simultaneously connecting the sub-element to the already at least partially produced container,
wherein, the sub-element comprises a mouthpiece and/or a handle and/or a thread, wherein, the thread is pressed after the production of the thread.

6. The method according to claim 1, wherein at least one further fiber-containing material is applied to container positions by means of the controlled application head, wherein the at least one further fiber-containing material is different from the material comprising the fibers.

7. The method according to claim 1, wherein identification information and/or durability information is embossed on the container by means of the controlled application head.

8. The method according to claim 1, wherein at least one support is provided within the container, which support connects two or more inner regions of the container.

9. The method according to claim 8, wherein the at least one support comprises a tension band for a bottom of the container and/or at least one horizontally circulating tension band and/or at least one obliquely extending tension band, wherein these tension bands comprise long-fiber material.

10. The method according to claim 1, wherein a bottom of the container comprises multiple segments circular segments, wherein a bottom thickness of the segment is smaller than a bottom thickness of a partition wall of the segments.

11. The method according to claim 1, wherein an inner region of the container is formed in a flow-optimized manner by means of the controlled application head.

12. The method according to claim 1, wherein a coating is applied to an inner surface and/or an outer surface of the produced container by means of a 3D printer, wherein the coating comprises a nanolayer.

13. The method according to claim 1, wherein a coating is applied to an outer surface of the produced container by immersion in a coating bath, wherein the coating comprises a resin.

14. A device for carrying out the method according to claim 1, wherein the device comprises at least one controlled application head for applying material comprising the fibers to container positions.

15. The device according to claim 14, further comprising a 3D printer and/or a multi-axis robot for moving the at least one controlled application head, wherein the multi-axis robot comprises a hydraulic, pneumatic, electromechanical or hydropneumatic actuator.
